(19) United States
(12) Patent Application Publication
(10) Pub. No.: US 2004/0161108 A1
(43) Pub. Date: Aug. 19, 2004

(54) Watermark processing device and watermark processing method

(75) Inventors: Hideo Ando, Hino-shi (JP); Hisashi Yamada, Yokohama-shi (JP); Tadashi Kojima, Yokohama-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/732,447

(22) Filed: Dec. 11, 2003

(30) Foreign Application Priority Data
Feb. 14, 2003 (JP) 2003-037177

(51) Int. Cl. H04N 7/167

(52) U.S. Cl. 380/201

(57) ABSTRACT

Upon outputting an analog output of digital contents with a watermark, that watermark is embedded in the analog output. Upon outputting an analog output of digital contents without any watermark, if its copy control information indicates copy inhibition, a separately generated watermark is embedded in the analog output. As a result, a watermark is embedded in an analog output of contents to be copy-protected (even when original digital contents have no watermark). Hence, an analog output of existing contents to be copy-protected without any watermark can be protected, due to the presence of the watermark, from being illicitly copied.

### CROSS-REFERENCE TO RELATED APPLICATIONS

This application is based upon and claims the benefit of priority from the prior Japanese Patent Application No. 2003-037177, filed Feb. 14, 2003, the entire contents of which are incorporated herein by reference.

### BACKGROUND OF THE INVENTION

1. Field of the Invention

The present invention relates to a watermark processing device and watermark processing method, which prevent or suppress an illicit copy after digital contents are converted into analog data.

2. Description of the Related Art

As is known, many digital audio/video (AV) contents are distributed in recent years. Of these contents, most of pay contents are copy-protected. Various copy protection methods have been proposed. Digital contents are effectively copy-protected without damaging their quality by appropriately combining copy control information (abbreviated as CCI) and a watermark (abbreviated as WM). However, after such contents are converted into an analog signal, there is no effective method of reliably preventing an illicit copy without adversely influencing the quality of the analog signal.

That is, under the existing circumstances, a source device (digital video layer, digital video recorder, digital broadcast tuner, or the like) and sink device (analog video display, analog video recorder, or the like) are still often analog-connected. In such case, it is difficult to copy-protect contents, which are in an analog state at a signal transfer portion between the source and sink devices, effectively (without damaging the quality of the contents).

As for copy protection of analog video contents, a method of inserting anti-copy pulses in a sync signal is known. However, with this method, the image quality is often adversely influenced in some displays or signal switchers (especially, the influence is serious in case of analog component connection that requires high image quality). In high-image quality contents (progressive or hi-vision video contents sent as components) in recent years, a requirement “not to adversely influence the quality of an analog signal” sent to a monitor display (especially, High Definition display) is particularly important, but it is difficult for the method of inserting anti-copy pulses in a sync signal to satisfactorily meet such requirement.

As one method which can meet the above requirement, an “analog copy protect system” described in Jpn. Pat. Appln. KOKAI Publication No. 2000-358227 (FIG. 1, FIG. 23; paragraph Nos. 0035 and 0036, paragraph Nos. 0185 to 0192) is known.

This system does not adopt the method of inserting anti-copy pulses in a sync signal. Instead, component signals are scrambled by frequently replacing signal lines or signal phases of the component signals (FIG. 23).

In this system, a descramble circuit for scrambled analog component signals is built in a special ACP adapter, which can never be detached once it is attached to a monitor display (the adapter is broken if it is detached forcedly) (FIG. 1). This system allows a viewer to normally view descrambled analog component signals but prevents descrambled analog component signals from being illegally output and being illicitly copied.

The “analog copy protect system” disclosed in above Japanese patent document is excellent in that an analog video signal can be prevented from being illicitly copied without adversely influencing the quality of high-image quality contents (progressive or hi-vision video contents sent as components). However, a service person must individually attach a dedicated ACP adapter to an existing monitor display which has the descramble circuit.

The present invention has been made to solve a problem in that contents can be reliably prevented from being illicitly copied if they are in a digital state but cannot be protected from any illicit copies once they are converted into an analog signal.

### BRIEF SUMMARY OF THE INVENTION

A watermark processing device according to an embodiment of the present invention is configured to receive a digital input in which a watermark (WM) and/or copy control information in addition to the watermark are/is inserted as needed, and to output an analog output corresponding to this digital input. In this device, when a watermark has already been inserted in a digital input, an analog output with that watermark (WM-1) is output. On the other hand, when no watermark is inserted in a digital input but copy control information is inserted and includes copy limitation information (copy never or no-more copy), a predetermined watermark is inserted (marked) in the digital input (before analog conversion), and an analog output with the watermark (WM-2) is output.

A watermark processing method according to an embodiment of the present invention is configured to receive a digital input in which a watermark (WM) and/or copy control information in addition to the watermark are/is inserted as needed, and to output an analog output corresponding to this digital input. In this method, when a watermark has already been inserted in a digital input (“with WM”), an analog output with that watermark (WM-1) is output. On the other hand, when no watermark is inserted in a digital input but copy control information is inserted and includes copy limitation information (copy never or no-more copy), a predetermined watermark is inserted (marked) in the digital input (before analog conversion), and an analog output with the watermark (WM-2) is output.

With this configuration, except for non-copy-protected contents, since a watermark (watermark WM-1 already inserted in a digital input or watermark WM-2 which is separately generated if WM-1 is not found) is embedded in an analog output, illicit copies can be prevented (or suppressed) from being diffused by this watermark.

### BRIEF DESCRIPTION OF THE SEVERAL VIEWS OF THE DRAWING

FIG. 1 is a block diagram showing an example of the basic arrangement of a watermark processing device according to an embodiment of the present invention;

FIG. 2 is a table that exemplifies how to embed a watermark in an analog output in processor 112 in FIG. 1;

FIG. 3 is a flow chart for explaining a watermark processing method according to an embodiment of the present invention;

FIG. 4 is a block diagram for explaining an example of the internal arrangement of processor 112 in FIG. 1;

FIG. 5 is a block diagram for explaining another example of the internal arrangement of processor 112 in FIG. 1;

FIG. 6 is a schematic block diagram for explaining the arrangement of a contents recording/playback apparatus (HDD/DVD recorder) which incorporates a watermark processing device according to an embodiment of the present invention;

FIG. 7 is a flow chart for explaining a watermark display/detection process;

FIG. 8 is a view for explaining an example of a window which displays a text message indicating that contents are inhibited from being copied;

FIG. 9 is a view for explaining an example of a window which displays a symbol indicating that contents are inhibited from being copied;

FIG. 10 is a view for explaining an example of a window which displays a text message indicating that contents can be copied only once;

FIG. 11 is a view for explaining an example of a window which displays a text message indicating that contents are free to copy;

FIG. 12 is a flow chart for explaining a contents process example (part 1);

FIG. 13 is a flow chart for explaining a contents process example (part 2);

FIG. 14 is a schematic block diagram for explaining the arrangement of a new watermark embedding unit in watermark processor 23 in FIG. 6;

FIG. 15 is a schematic block diagram for explaining the arrangement of a watermark detection processor in watermark processor 23 in FIG. 6; and

FIG. 16 is a view for explaining detection of a correlation value of phase shift with respect to a watermark.

### DETAILED DESCRIPTION OF THE INVENTION

A preferred embodiment of the present invention will be described in detail hereinafter with reference to the accompanying drawings.

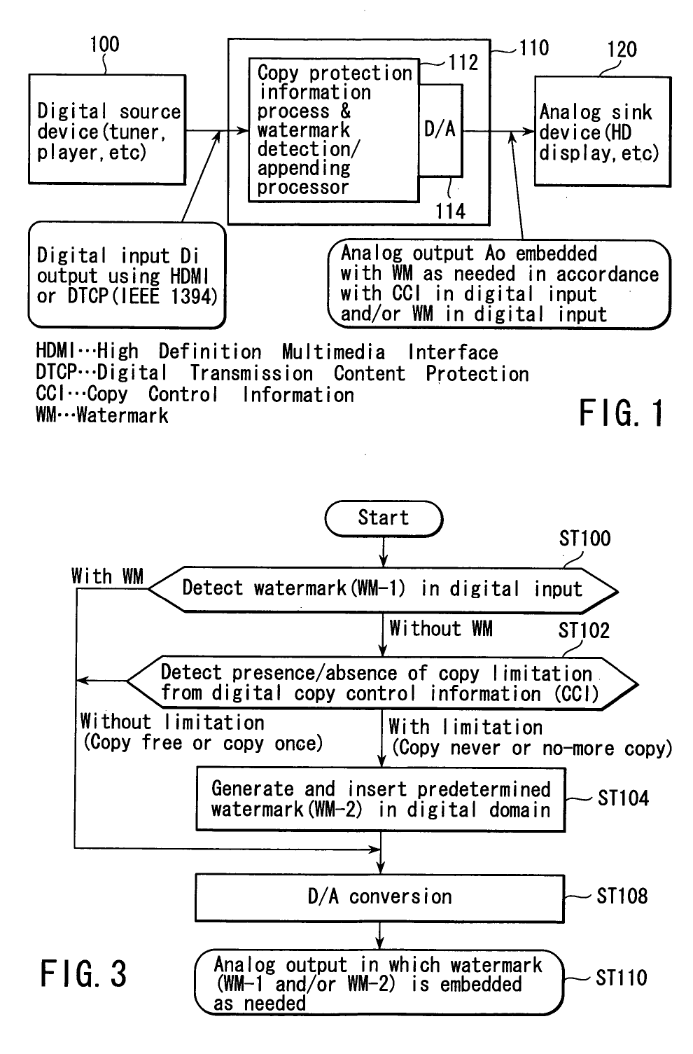

FIG. 1 is a block diagram for explaining an example of the basic arrangement of a watermark processing device according to an embodiment of the present invention. As a digital source device exemplified in this embodiment, for example, a BS digital tuner or a DVD player (or DVD recorder) with digital AV outputs is available. Also, as analog sink device 120 exemplified in this embodiment, for example, an HD (High Definition) display with analog component inputs (Y/Cb/Cr; Y/U/V; Y/Pb/Pr; etc.) is available. This analog sink device 120 may also be an HD display of another type which receives a composite video signal (standard NTSC video signal or the like) or Y/C-separated S signal by one input terminal, internally converts the received video signal into a progressive video signal or internally up-converts that signal to an HD video signal. Or analog sink device 120 may be an analog TV monitor with a normal composite video input (pin inputs or S-terminal input) if high resolution is not required. This sink device 120 is a video monitor with only a video input or a television monitor with video+audio inputs in some cases. Also, an audio amplifier (or AV amplifier) may be handled as sink device 120.

Decoder (watermark processing device) 110 according to the present invention is inserted between digital source device 100 and analog sink device 120.

In this embodiment, a digital output from digital source device 100 can be made based on, e.g., HDMI (High Definition Multimedia Interface) or DTCP (Digital Transmission Control Protection) using IEEE 1394. That is, copy control information CCI and watermark WM complying with HDMI or DTCP can be appended (marked) to digital input Di to decoder 110 as needed. (The watermark itself can contain similar copy control information.)

HDMI allows video signal transmission in a video/audio format (YPbPr, YCbCr, or YUV) complying with EIA/CEA-861-B, and also allows transmission of multi-channel audio data. This HDMI is compatible to existing DVI (Digital Visual Interface).

In HDMI, an audio signal is transmitted in the vertical/horizontal blanking periods of a video signal.

On the other hand, IEEE 1394 allows transmission of multi-channel audio data together with a component video signal. IEEE 1394 interfaces will be prevalent in actual DVD products (players/recorders) in the future, but digital devices with IEEE 1394 interfaces have already been accepted in the marketplace. For example, a BS digital tuner adopts an IEEE 1394 interface. (For some AV contents, a wireless system that applies DTCP to “Bluetooth®” can be used to transmit digital input Di.)

HDMI or DTCP has a function of authentication between connected devices (mutual authentication and key exchange), contents encryption, transmission of copy control information (CCI), and system renewability.

Note that copy control information CCI can include four different types of copy control information (copy never that absolutely inhibits any copies independently of situations; no-more copy that allows no further copies; copy once that allows only one copy; and copy free that allows free copies).

When copy control information CCI is applied to IEEE 1394/DTCP, the transmission side sets an encryption mode (copy free, copy once, no-more copy, copy never, or the like) in an EMI (Encryption Mode Indicator) of a 1394 header according to, e.g., the CCI value of contents, and designates an encryption key generation mode (note that the EMI is not encrypted but the embedded CCI is encrypted). The reception side sets a decryption key generation mode (copy free “00”, copy once “10”, no-more copy “01”, copy never “11”, or the like) in accordance with, e.g., the EMI.

Decoder 110 in FIG. 1 is configured to output analog output Ao embedded with watermark WM as needed to analog sink device (HD display with analog component inputs or the like) 120 in accordance with the contents of copy control information CCI with the above contents and/or watermark WM embedded in digital input Di as needed (“copy free, copy once, no-more copy, copy never” or the like” of CCI and/or WM). That is, if copy control information CCI has copy inhibition contents (“no-more copy, copy never” or the like), watermark WM is embedded (marked) in analog output Ao irrespective of the presence/absence of watermark WM in input Di. If watermark WM has already been embedded in input Di, watermark WM (corresponding to that embedded in input Di) is embedded in analog output Ao irrespective of the contents of copy control information CCI.

With this configuration, illicit copies of existing non-watermarked contents (but copy-inhibited) via “an analog state” can be prevented or suppressed. For example, assume that a source device is a DVD video player and a DVD video disk written with copy inhibition information (without any watermark) is played back by this player. In this case, processor 112 in decoder 110 in FIG. 1 extracts copy control information CCI from digital input (video) Di from source device (DVD video player) 100, and detects that the input digital contents are copy-inhibited (e.g., copy never). Then, processor 112 embeds internally generated watermark WM (indicating copy never) in contents of digital input Di, and passes the watermarked contents to D/A converter 114 to D/A-convert the contents. In this manner, analog output (video) Ao embedded with watermark WM is output to analog sink device 120.

Assume that analog output Ao embedded with watermark WM (indicating copy never) is sent to a video input of an analog video player (or an analog video input of a digital video recorder), and is to be recorded. In this case, if a recorder for video recording has a watermark detection function, video recording is inhibited.

If a recorder for video recording is a recorder/player which has no watermark detection function (watermark incompatible machine; e.g., a conventional analog video cassette recorder), analog output Ao can be recorded together with watermark WM. However, even when the recorder/player is a watermark incompatible analog video cassette recorder, watermark WM is embedded in its analog playback output. For this reason, even when that analog playback output is to be further copied using an advanced, watermark-compatible recorder/player (e.g., a digital disc recorder or the like), that copy process cannot be done. Incidentally, such conventional analog video cassette recorder cannot attain video recording/playback while maintaining the original quality of high-quality digital video contents. In this sense, even if analog video recording/playback can be done in form, an illicit copy of high-quality digital contents (especially, digital HD video contents) is substantially suppressed.

The analog playback output (embedded with watermark WM) can be further copied (to form grandchild copy, great grandchild copy, and the like) using a conventional, watermark incompatible analog video cassette recorder. However, analog video recording/playback inevitably impairs signal quality every copy generation. For this reason, there is no fear of an exponential increase of illicit copies of high-quality contents (while maintaining high quality). Also, since the conventional analog video cassette recorder cannot cope with high-quality digital video recording, such conventional analog video cassette recorders will gradually disappear in the era of digital HD video contents (such era has already been reached).

Consumer high-quality digital recorders/players in the era of digital HD video contents will all become watermark WM compatible machines, and there will be no fear of illicit copies of copy-protected contents “via an analog signal line” as long as watermark WM is embedded in an analog output (illicit copies “via a digital signal line” are reliably prevented by copy control information embedded in digital information).

Note that digital input Di can contain video contents V and/or audio contents A. That is, in case of a movie or the like, the digital input contains video+audio contents. In case of music without any video, the digital input contains only audio contents. In case of video-only contents without any audio, the digital input contains only video contents although such contents are exceptional.

Assume that the digital input contains video+audio contents (AV contents), and a watermark and copy control information can be appended to both video and audio contents. In such situation, the watermark processing device according to the embodiment of the present invention can be configured as follows.

That is, when a watermark has already been inserted in digital input Di of video contents V, analog video output (AoV) with that watermark (WM-1V) is output. When no watermark is inserted in digital input Di of video contents V, but its copy control information CCI contains copy limitation information (copy never or no-more copy), a predetermined watermark (WM-2V) is inserted before analog conversion, and an analog video output (AoV) with the watermark (WM-2V) is output.

In case of an analog composite video signal, the video watermark (WM-1V or WM-2V) is embedded in, e.g., its baseband. In case of analog component video signals, the video watermark (WM-1V or WM-2V) is embedded in, e.g., a color difference signal component (Cb and/or Cr, or the like). If no damage on image quality is visually observed, the video watermark (WM-1V or WM-2V) may be embedded in a luminance signal component (Y).

Likewise, when a watermark has already been inserted in digital input Di of audio contents A, analog audio output (AoA) with that watermark (WM-1A) is output. When no watermark is inserted in digital input Di of audio contents A but its copy control information CCI contains copy limitation information (copy never or no-more copy), a predetermined watermark (WM-2A) is inserted before analog conversion, and an analog video output (AoA) with the watermark (WM-2A) is output.

Note that the audio watermark (WM-1A or WM-2A) can be embedded in, e.g., the range equal to or lower than the playback lower limit (10 to 20 Hz or less) of the audio frequency band and/or the range equal to or higher than the playback upper limit (a transmission frequency band of 40 to 80 kHz or higher) of the audio frequency band (at a discreet signal level so as not to cause sound quality deterioration). If audio contents have two or more channels, the watermark may be embedded in all the channels or in some of these channels. For example, in case of 5.1ch surround audio contents, the watermark may be embedded in only a subwoofer channel (0.1ch), or a front center channel or rear channels.

According to the arrangement shown in FIG. 1, the watermark can be automatically inserted in analog output Ao on the basis of a combination of watermark WM and copy control information CCI in digital input Di (contents to be watermarked can be either video or audio contents).

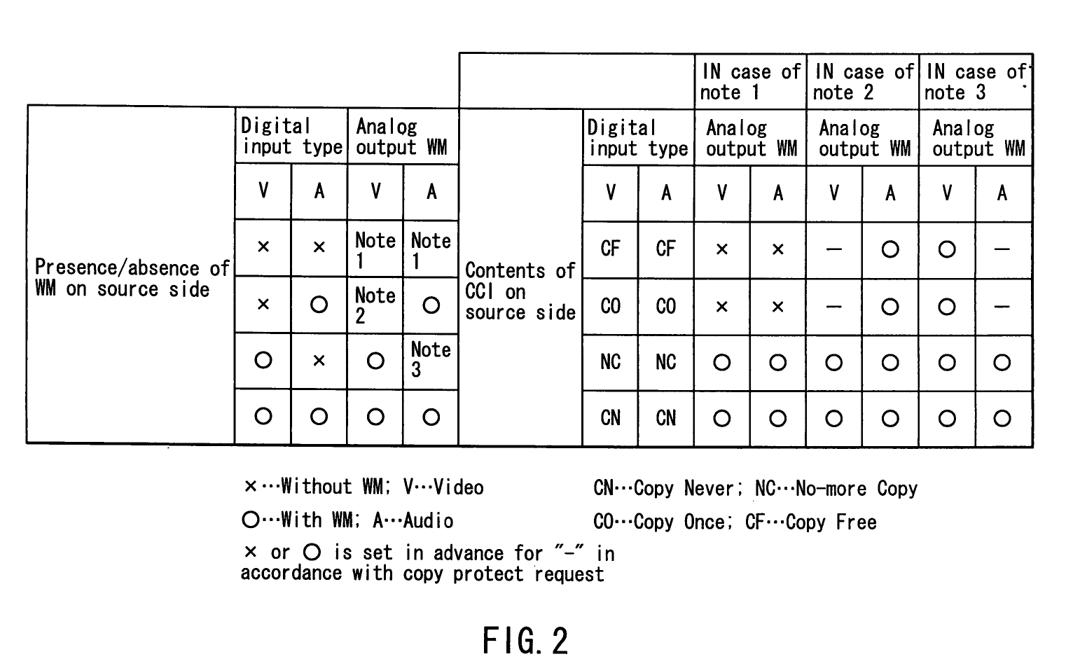

FIG. 2 is a table that exemplifies how to embed a watermark in an analog output in processor 112 in FIG. 1. FIG. 2 exemplifies a case wherein the number of types of contents to be handled by digital input Di and analog output Ao is two (video and audio). (The same applies to a case wherein other contents such as service information contained in digital broadcast are available in addition to video and audio contents, although the number of possible combinations increases.)

The left side of FIG. 2 exemplifies a case wherein video V and audio A are available as digital input Di from source device 100, and video V and audio A are also available as analog output Ao to sink device 120 in correspondence with input Di. Note that x indicates a case wherein no watermark is embedded, and o indicates a case wherein a watermark is embedded.

The right side of FIG. 2 exemplifies watermark WM to be embedded in video V and audio A on the analog output Ao side in correspondence with combinations of the presence/absence of watermark WM embedded in video V and audio A on the digital input Di side and copy control information CCI on the digital input Di side.

(1) That is, if no watermark is detected from video V and audio A of digital input Di (V=X/A=X; note 1), watermarks of video V and audio A of analog output Ao are determined as follows depending on copy control information CCI in digital input Di.

(1-1) If no watermark is detected from video V and audio A of digital input Di (V=X/A=X) and both video V and audio A of digital input Di are copy free (abbreviated as CF), no watermark is embedded in both video V and audio A of analog output Ao (V=X/A=X; the CF row in the columns of note 1 on the right side of FIG. 2).

(1-2) If no watermark is detected from video V and audio A of digital input Di (V=X/A=X) and both video V and audio A of digital input Di are copy once (abbreviated as CO), no watermark is embedded in both video V and audio A of analog output Ao (V=X/A=X; the CO row in the columns of note 1 on the right side of FIG. 2).

(1-3) If no watermark is detected from video V and audio A of digital input Di (V=X/A=X) and both video V and audio A of digital input Di are no-more copy (abbreviated as NC), a watermark is embedded in both video V and audio A of analog output Ao (V=◯/A=◯; the NC row in the columns of note 1 on the right side of FIG. 2).

(1-4) If no watermark is detected from video V and audio A of digital input Di (V=X/A=X) and both video V and audio A of digital input Di are copy never (abbreviated as CN), a watermark is embedded in both video V and audio A of analog output Ao (V=◯/A=◯; the CN row in the columns of note 1 on the right side of FIG. 2).

(2) If no watermark is detected from video V of digital input Di but a watermark is detected from audio A (V=X/A=◯; note 2), a watermark of audio A of analog output Ao is fixed to “embedded” (A=◯), but a watermark of video V is determined as follows depending on copy control information CCI in digital input Di and other circumstances.

(2-1) If both video V and audio A of digital input Di are copy free (CF), a watermark is unconditionally “embedded” in audio A of analog output Ao (A=◯), but a watermark of video V of analog output Ao is determined by other circumstances (V=-; the CF row in the column of note 2 on the right side of FIG. 2).

One example of “other circumstances” is a request of a contents provider. That is, if the contents provider requests “to embed a watermark in an analog output of video contents if audio contents to be played back simultaneously with that video contents contain a watermark, although no watermark is originally embedded in video contents”, V=“-” in the CF row of the column of note 2 on the right side of FIG. 2 becomes V=“◯”.

On the other hand, if “no watermark need be embedded in an analog video output as long as a watermark is embedded in an analog audio output”, V=“-” in the CF row of the column of note 2 on the right side of FIG. 2 becomes V=“X”.

(2-2) If both video V and audio A of digital input Di are copy once (CO), the same as (2-1) above applies (V=-/A=◯; the CO row of the columns of note 2 on the right side of FIG. 2).

(2-3) If both video V and audio A of digital input Di are no-more copy (abbreviated as NC), a watermark is “embedded” in both video V and audio A of analog output Ao (V=◯/A=◯; the NC row in the columns of note 2 on the right side of FIG. 2).

(2-4) If both video V and audio A of digital input Di are copy never (CN), the same as (2-3) above applies (V=◯/A=◯; the CN row of the columns of note 2 on the right side of FIG. 2).

(3) If a watermark is detected from video V of digital input Di but no watermark is detected from audio A (V=◯/A=X; note 3), a watermark of video V of analog output Ao is fixed to “embedded” (V=◯), but a watermark of audio A is determined as follows depending on copy control information CCI in digital input Di and other circumstances.

(3-1) If both video V and audio A of digital input Di are copy free (CF), a watermark is unconditionally “embedded” in video V of analog output Ao (V=◯), but a watermark of audio A of analog output Ao is determined by other circumstances (A=-; the CF row in the column of note 3 on the right side of FIG. 2).

One example of “other circumstances” is a request of a contents provider. That is, if the contents provider requests “to embed a watermark in an analog output of audio contents if video contents to be played back simultaneously with that audio contents contain a watermark, although no watermark is originally embedded in audio contents”, A=“-” in the CF row of the column of note 3 on the right side of FIG. 2 becomes A=“◯”.

On the other hand, if “no watermark need be embedded in an analog audio output as long as a watermark is embedded in an analog video output”, A=“-” in the CF row of the column of note 3 on the right side of FIG. 2 becomes A=“X”.

(3-2) If both video V and audio A of digital input Di are copy once (CO), the same as (3-1) above applies (V=◯/A=-; the CO row of the columns of note 3 on the right side of FIG. 2).

(3-3) If both video V and audio A of digital input Di are no-more copy (abbreviated as NC), a watermark is “embedded” in both video V and audio A of analog output Ao (V=◯/A=◯; the NC row in the columns of note 3 on the right side of FIG. 2).

(3-4) If both video V and audio A of digital input Di are copy never (CN), the same as (3-3) above applies (V=◯/A=◯; the CN row of the columns of note 3 on the right side of FIG. 2).

Note that a factor that determines the “other circumstances” is not limited to the request from the contents provider. For example, a device manufacturer who designs and vends decoder 110 shown in FIG. 1 can determine whether “-” is to be set to “◯” or “X” in the design process. For example, in the columns of note 2 or 3 in FIG. 2, “-” can be set to “X” to indicate “without watermark” in the CF row, and “-” can be set to “◯” to indicate “with watermark” in the CO row. In this case, when copy-once contents are copied via analog output Ao, a watermark is embedded in the copied AV contents. If CCI control of the contents is illicitly canceled by any means, the watermark remains in subsequent illicit copies.

(4) If watermarks are “detected” from both video V and audio A of digital input Di (V=◯/A=◯), watermarks are also “embedded” in video V and audio A of analog output Ao (V=◯/A=◯) irrespective of the contents of copy control information CCI in digital input Di.

When the configuration shown in FIG. 2 is applied to the arrangement shown in FIG. 1, objects to be watermarked can be expanded to one or more types of contents (video and/or audio in the example of FIG. 2).

Note that SCMS (Serial Copy Management System) is also available as the copy control method of digital contents. This SCMS is also a kind of copy control information, and can designate copy free, copy once, and copy never (SCMS does not specify no-more copy, but if no-more copy and copy never are equally handled, matching between SCMS and DTCP can be achieved).

When SCMS is used as copy control information CCI, the following method can be adopted (assume that SCMS is transferred in a copy free state).

Check 1 . . . Check Availability of Encryption

if Encryption is available, make required Decryption and execute playback. SCMS is unconditionally set to copy once;

if no Encryption is available, go to check 2;

Check 2 . . . Confirm if Watermark is Detected

if watermark WM is detected, go to check 3;

if no watermark WM is detected, go to check 4;

Check 3 . . . Check Value of Watermark WM

if WM=“00” (copy free), execute playback. SCMS=“00” (copy free);

if WM=“01” (copy never), do not execute playback (inhibit both analog and digital outputs). SCMS=“01” (copy never);

Check 4 . . . Confirm Digital Copy Control Information CCI

if CCI=“00” (copy free), SCMS=“00” (copy free);

if CCI=“10” (copy once), SCMS=“10” (copy once);

if CCI=“01” (copy never) or “11” (no-more copy), SCMS=“01” (copy never).

FIG. 3 is a flow chart for explaining the watermark processing method according to the embodiment of the present invention.

If a watermark (WM-1) is inserted in digital input Di in FIG. 1 (“with WM” in ST100), the contents with the watermark (WM-1) are D/A-converted (ST108) to output an analog output (Ao) (ST110). If no watermark is inserted in digital input Di (“without WM” in ST100) but copy control information CCI contains copy limitation information (copy never or no-more copy) (“with limitation” in ST102), a predetermined watermark (WM-2) is inserted before analog conversion (ST104). The contents with the watermark. (WM-2) are D/A-converted (ST108) to output an analog output (Ao) with the watermark (WM-2) (ST110).

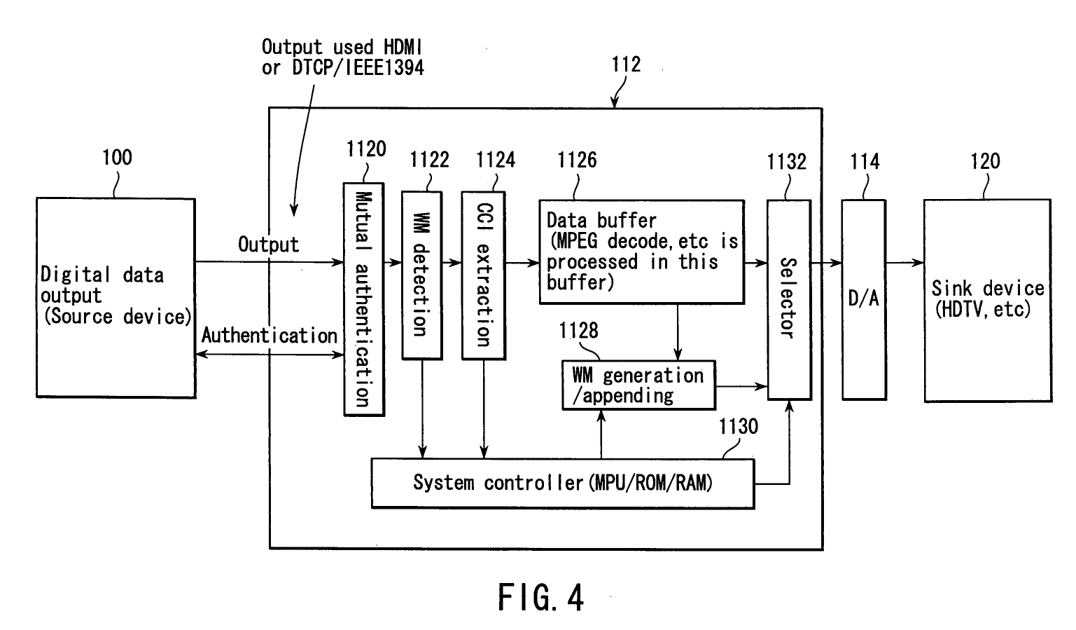

FIG. 4 is a block diagram for explaining an example of the internal arrangement of processor 112 in FIG. 1. This processor 112 comprises authentication processor 1120 for making mutual authentication (device authentication) with source device 100, WM detector 1122 for detecting watermark WM from digital contents sent from source device 100 after authentication, CCI extractor 1124 for extracting copy control information CCI from digital contents sent from source device 100 after authentication, and data buffer 1126 for processing digital contents sent from source device 100 after authentication. If incoming digital contents have been encoded (by, e.g., MPEG), buffer 1126 is also used to decode the digital contents. Image information or the like after the decode process in buffer 1126 is sent to WM generation/appending unit 1128 to embed watermark EM in that information as needed.

Watermark WM (WM-1) detected by WM detector 1122 and copy control information CCI extracted by CCI extractor 1124 are sent to system controller 1130. System controller 1130 includes a microcomputer MPU, control program ROM, data ROM, work RAM, and the like, and is configured to execute the process exemplified in FIG. 3.

More specifically, if WM detector 1122 detects a watermark (WM-1), digital contents (with WM-1) decoded by buffer 1126 are sent to D/A converter 114 via selector 1132 to be converted into analog output Ao (with a watermark corresponding to WM-1). Then, analog output Ao is supplied to sink device 120.

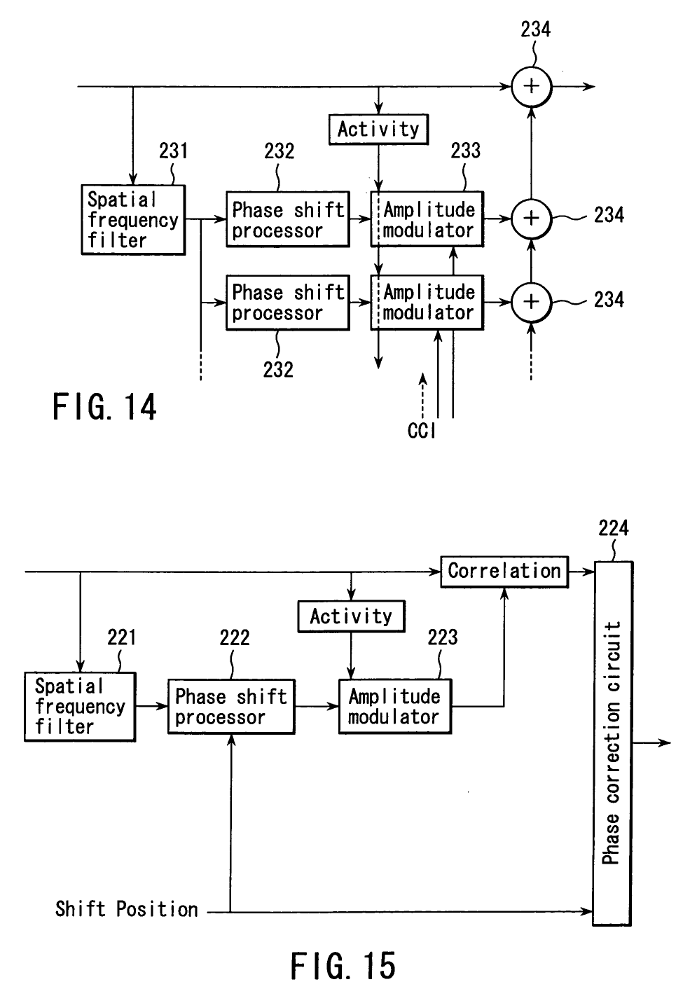

If WM detector 1122 does not detect any watermark (WM-1), WM generation/appending unit 1128 generates a predetermined watermark (WM-2) in accordance with the contents (see FIG. 2) of copy control information CCI extracted by CCI extractor 1124 (an example of the generation method will be explained later with reference to FIG. 14 and the like).

The WM-2 generation process requires some time from when necessity of its generation is determined until generation is completed. The decoded digital contents stand by in buffer 1126 for the time until completion of generation. Upon completion of generation of the predetermined watermark (WM-2) corresponding to the contents of extracted copy control information CCI, this WM-2 is appended to the decoded contents in buffer 1126, and the contents appended with WM-2 are sent to D/A converter 114 via selector 1132. Then, D/A-converted analog output Ao (with a watermark corresponding to WM-2) is supplied to sink device 120.

The arrangement in FIG. 4 (corresponding to the processing sequence in FIG. 3) is characterized in that the presence/absence of watermark WM is determined in preference to copy control information CCI, and buffer 1126 used to decode contents also has a timing adjustment function with contents upon appending internally generated watermark WM-2. (If such function is not assigned to buffer 1126, a timing adjustment buffer upon appending internally generated WM-2 is required in addition to, e.g., an MPEG decode buffer.)

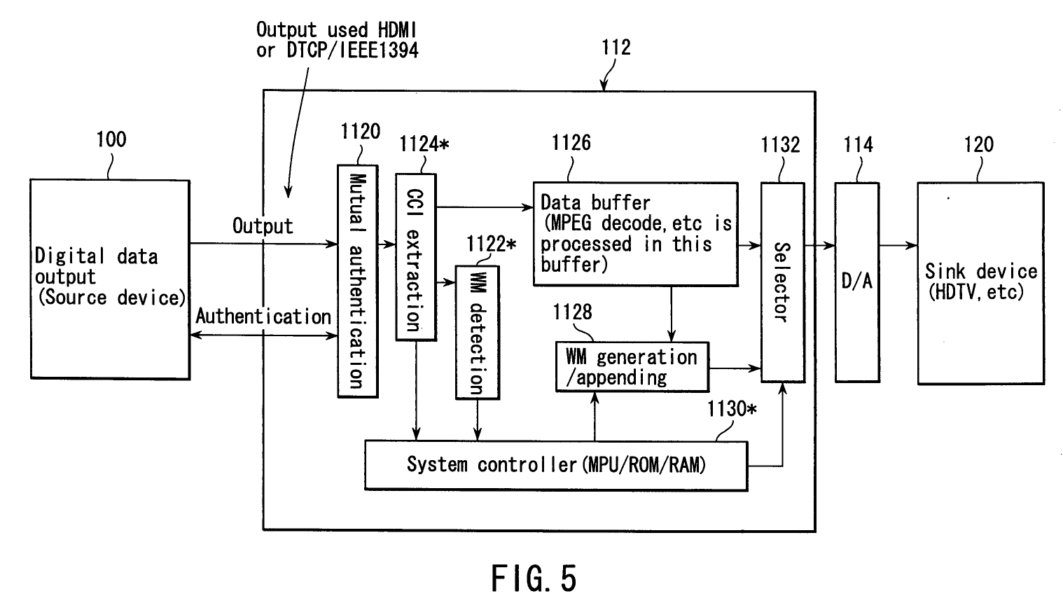

FIG. 5 is a block diagram for explaining another example of the internal arrangement of processor 112 in FIG. 1. The arrangement shown in FIG. 5 is different from that in FIG. 4 in that watermark detector 1122 and copy control information extractor 1124 in the arrangement of FIG. 4 are replaced. Accordingly, the processing sequence of the internal control program of system controller 1130* is changed.

More specifically, CCI extractor 1124* checks whether or not input digital contents are copy-protected. Upon completion of this checking process, WM detector 1122* checks whether or not a watermark (WM-1) is embedded in the input contents. If the watermark (WM-1) is embedded, the digital contents decoded by buffer 1126 are sent to D/A converter 114 and are D/A-converted. Then, analog output Ao with a watermark (corresponding to WM-1) is sent to sink device 120.

If no watermark (WM-1) is embedded, WM generation/appending unit 1128 generates a predetermined watermark (WM-2) on the basis of the contents of extracted CCI (see FIG. 2), and appends the generated watermark (WM-2) to the digital contents decoded by buffer 1126. In this way, the contents embedded with watermark WM-2 are converted into analog output Ao by D/A converter 114, and analog output Ao is sent to sink device 120.

In the arrangement of FIG. 5, CCI check is executed prior to WM detection that requires a relatively long time, and immediately after CCI check, input contents are sent to data buffer 1126 to undergo an MPEG decode process and the like. In this manner, WM detector 1122* can start a watermark (WM-1) detection process parallel to the MPEG decode process and the like in buffer 1126.

In the above description, input Di to decoder 110 is digital contents, but this input Di includes digital contents obtained by converting analog contents. For example, a case will be examined below wherein analog video data which initially undergoes copy management in an analog copy generation management system (CGMS-A) is A/D-converted and digitally recorded, and the digitally recorded contents then undergo copy management in a digital copy generation management system (CGMS-D). In such case, if digital contents managed by this CGMS-D are used as input Di to decoder 110 according to the present invention, even when no watermark (WM-1) is embedded in the first analog contents (and the converted digital contents), a watermark (WM-2) can be embedded as needed in analog output. Ao from decoder 110 (in accordance with the contents of CGMS-D).

When the source is DVD video, copyright management information (CPR_MAI) written in the data sector can be used as copy control information CCI.

Also, digital transmission between source device 100 and decoder 110 in FIG. 1 can be achieved using any of copper wire, light, and radio.

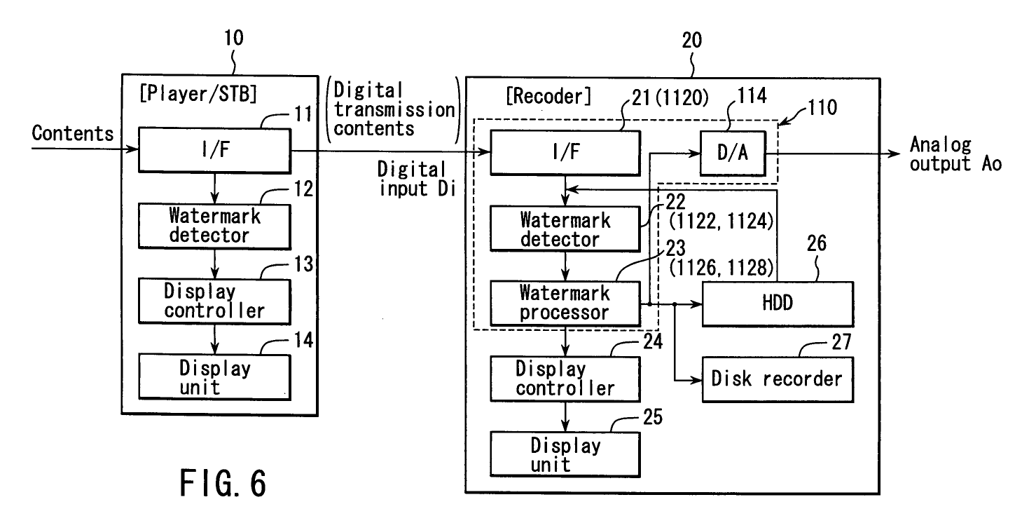

FIG. 6 is a schematic block diagram for explaining the arrangement of a contents recording/playback apparatus (HDD/DVD recorder) which incorporates the watermark processing device according to the embodiment of the present invention. In this embodiments, components 21 to 23 and D/A converter 114 correspond to decoder 110 in FIG. 1.

In this embodiment, assume that a watermark (WM) is embedded in contents, and this watermark contains copy control information (CCI). Upon displaying contents, the copy control information is presented to the user at the same time or at a unique timing.

FIG. 6 shows the schematic arrangement of the contents recording/playback apparatus. This contents recording/playback apparatus is an example of a recording apparatus of contents which contain a watermark according to the embodiment of the present invention. As shown in FIG. 6, the contents recording/playback apparatus comprises player/STB (set top box) 10, and recorder 20. Player/STB 10 comprises interface (I/F) 11, watermark detector 12, display controller 13, and display unit 14. Recorder 20 comprises interface (I/F) 21, watermark detector 22, watermark processor 23, display controller 24, display unit 25, hard disk drive (HDD) 26, and disc recorder 27 (e.g., a DVD recorder for recording digital AV information on an optical disc such as a DVD-RAM, DVD-RW, or DVD-R).

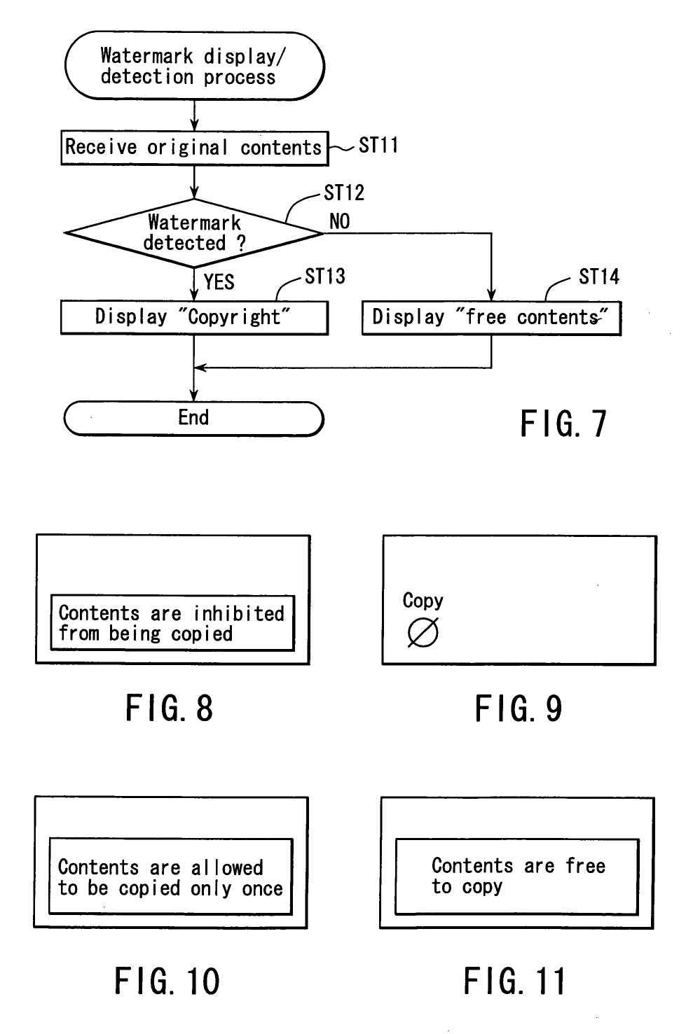

The process upon playing back contents will be explained below with reference to the flow chart shown in FIG. 7. FIG. 7 is a flow chart for explaining a watermark detection/display process.

Original contents provided by satellite broadcast (BS) are received via interface 11 of player/STB 10 (ST11), and are played back by player/STB 10. If a watermark (WMorg) is embedded in the original contents, watermark detector 12 of player/STB 10 detects this watermark (WMorg).

If watermark detector 12 detects a watermark (WMorg) from the original contents (ST12, YES), a detection message of the watermark (WMorg) is sent to display controller 13. Upon reception of this message, display controller 13 controls display unit 14 to display information indicating that the received contents are copyrighted. As an example of display, display unit 14 displays “copyright” (ST13). The information indicating that contents are copyrighted is displayed at the same timing as contents display, or at a unique timing irrespective of contents display. Copy control information contained in the watermark (WMorg) is decoded, and if copy limitation is applied, a message that advises accordingly may be displayed.

If watermark detector 12 does not detect any watermark (WMorg) from the contents (ST12, NO), a non-detection message of the watermark is sent to display controller 13. Upon reception of this message, display controller 13 controls display unit 14 to display that the received contents are not copyrighted (if no copy control information other than a watermark is found). As an example of display, display unit 14 displays “free contents” (ST14). Or display unit 14 may not display any information.

Note that display unit 14 may be a display device (display window) built in the player/STB 10 main body, as shown in FIG. 6, or may be a display device such as a TV, CRT, or the like externally connected to player/STB 10.

FIGS. 8 to 11 show examples of the display contents displayed on the display unit.

FIG. 8 shows an example that displays a text message indicating that contents are copyrighted by a watermark embedded in the contents and are inhibited from being copied.

FIG. 9 shows an example that displays a symbol indicating that contents are copyrighted by a watermark embedded in the contents and are inhibited from being copied.

FIG. 10 shows an example that displays a text message indicating that contents can be copied only once when the contents are copyrighted by a watermark embedded in the contents and are allowed to be copied only once.

FIG. 11 shows an example that displays a text message indicating that contents are free to copy when the contents are not copyrighted by a watermark embedded in the contents and are allowed to be freely copied.

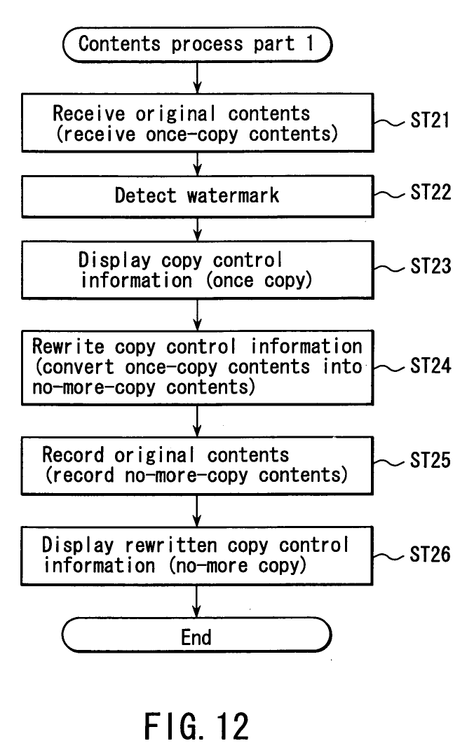

The copy process (part 1) of original contents which are permitted to be copied only once will be described below with reference to FIG. 12. Once-copy (or copy-once) contents (=original contents) are received via interface 11 of player/STB 10 (ST21). This once-copy contents are embedded with a watermark (WMorg), which contains copy control information that permits to copy only once. Watermark detector 12 of player/STB 10 detects the watermark (WMorg) embedded in the once-copy contents (ST22). At this time, display controller 13 instructs display unit 14 to display copy control information contained in the detected watermark (WMorg), and display unit 14 displays the copy control information (ST23). The display contents at that time are, e.g., “contents are permitted to be copied only once”.

Upon recording the once-copy contents, the once-copy contents output from interface 11 of player/STB 10 are input to interface 21 of recorder 20, and are temporarily stored in hard disk drive (HDD) 26. When the once-copy contents stored in hard disk drive 26 are to be recorded on a recording medium such as an optical disc or the like by disc recorder 27, watermark detector 22 detects the watermark (WMorg) contained in the once-copy contents. The watermark (WMorg) contained in the once-copy contents contains copy control information that permits to copy only once. That is, the detection process of watermark detector 22 detects the watermark (WMorg) from the once-copy contents and reveals that this watermark (WMorg) contains copy control information that permits to copy only once. At this time, watermark processor 23 rewrites the copy control information contained in the once-copy contents. More specifically, watermark processor 23 rewrites the copy control information which is contained in the once-copy contents and permits to copy only once to copy control information that does not permit to copy. Contents which contain the copy control information that does not permit to copy will be referred to as no-more-copy contents (or copy-never contents if a copy is inhibited from the beginning) hereinafter.

That is, the once-copy contents (copy control information=once copy) are converted into no-more-copy contents (copy control information=no-more copy) (or copy control information=copy never) (ST24) and the converted contents are recorded on a recording medium such as an optical disc or the like by disc recorder 27 (ST25). In this way, the contents recorded on the recording medium can no longer be recorded from this recording medium to another recording medium. Upon recording the no-more-copy contents (or copy-never contents) on the recording medium, display unit 25 displays the copy control information contained in the no-more-copy contents (or copy-never contents) (ST26). The display contents at that time are, e.g., “contents cannot be copied to another medium”.

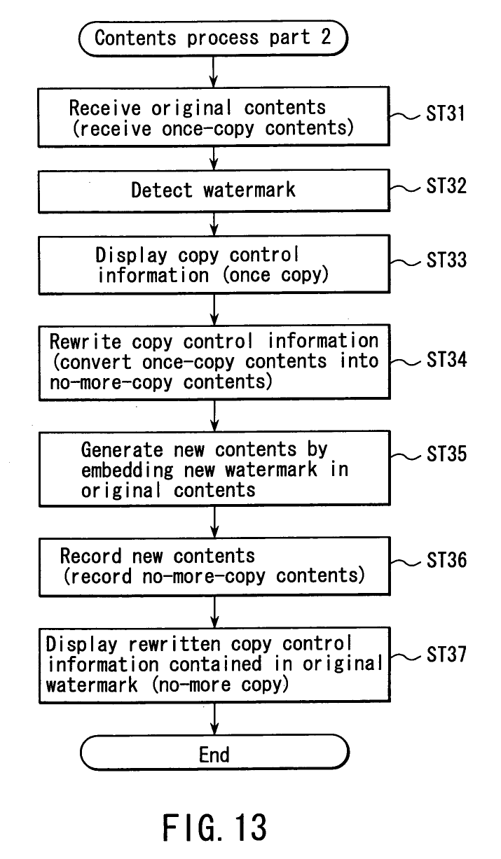

The copy process (part 2) of original contents which are permitted to be copied only once will be described below with reference to FIG. 13. Once-copy contents (=original contents) are received via interface 11 of player/STB 10 (ST31). This once-copy contents are embedded with a watermark (WMorg), which contains copy control information that permits to copy only once. Watermark detector 12 of player/STB 10 detects the watermark (WMorg) embedded in the once-copy contents (ST32). At this time, display controller 13 instructs display unit 14 to display copy control information contained in the detected watermark (WMorg), and display unit 14 displays the copy control information (ST33). The display contents at that time are, e.g., “contents are permitted to be copied only once”.

Upon recording the once-copy contents, the once-copy contents output from interface 11 of player/STB 10 are input to interface 21 of recorder 20, and are temporarily stored in hard disk drive (HDD) 26. When the once-copy contents stored in hard disk drive 26 are to be recorded on a recording medium such as an optical disc or the like by disc recorder 27, watermark detector 22 detects the watermark (WMorg) contained in the once-copy contents. The watermark (WMorg) contained in the once-copy contents contains copy control information that permits to copy only once. That is, the detection process of watermark detector 22 detects the watermark (WMorg) from the once-copy contents and reveals that this watermark (WMorg) contains copy control information that permits to copy only once. At this time, watermark processor 23 rewrites the copy control information contained in the once-copy contents. More specifically, watermark processor 23 rewrites the copy control information which is contained in the once-copy contents and permits to copy only once to copy control information that does not permit to copy. Contents which contain the copy control information that does not permit to copy will be referred to as no-more-copy contents (or copy-never contents) hereinafter.

Furthermore, watermark processor 23 embeds a new watermark (WMnew) in the no-more-copy contents in a format different from the original watermark (WMorg). Copy control information contained in the new watermark (WMnew) is the same as that contained in the original watermark (WMorg). That is, in this case, each of the copy control information contained in the original watermark (WMorg) and that contained in the new watermark (WMnew) is the copy control information that does not permit to copy.

To summarize, the once-copy contents (copy control information=once copy contained in original watermark WMorg) are converted into no-more-copy contents (copy control information=no-more copy; or copy control information=copy never contained in original watermark WMorg) (ST34) and a new watermark (WMnew) is embedded to generate new contents (ST35). The contents are then recorded on a recording medium such as an optical disc or the like by disc recorder 27 (ST36).

The new contents recorded on the recording medium can no longer be recorded from this recording medium to another recording medium due to the presence of the copy control information (=no-more copy or copy never) contained in the original watermark (WMorg) and the copy control information (=no-more copy or copy never) contained in the new watermark (WMnew). Since a copy is inhibited by double copy control information, the copyright is protected more securely. In other words, recorder 20 can copyright the contents.

Upon recording the new contents on the recording medium, display unit 25 displays the copy control information contained in the original watermark (WMorg) of the new contents (ST37). The display contents at that time are, e.g., “contents cannot be copied to another medium”. However, the copy control information contained in the new watermark (WMnew) is not displayed at all.

In the above description, the new contents are doubly copy-protected using two watermarks, i.e., original watermark WMorg and new watermark WMnew. However, the new contents may be copy-protected by only new watermark WMnew which has copy control information with the contents rewritten from the first copy control information of original watermark WMorg.

If the new contents can have two watermarks WMorg and WMnew, and are output from source device 100 to decoder 110 in FIG. 1, the following process can be executed. That is, if digital input Di contains at least one of WMorg and WMnew, decoder 110 embeds watermark WM-2 corresponding to WMorg and/or WMnew contained in digital input Di in analog output Ao.

The new watermark embedding process by watermark processor 23 will be described below with reference to FIG. 14. (This embedding process corresponds to the watermark appending process in processor 112 in FIG. 1, and also to the process of WM generation/appending unit 1128 shown in FIG. 4 or 5.)

FIG. 14 shows an example of the schematic structure (an actual process is implemented by a digital process) of a new watermark embedding unit in watermark processor 23. As shown in FIG. 14, the new watermark embedding unit in watermark processor 23 comprises digital spatial frequency filter (SFF) 231, digital phase shift processors (Phase Shift) 232, digital amplitude modulator (Amplitude Modulation) 233, digital adder 234, and the like.

Spatial frequency filter 231 extracts a specific spatial frequency component from original contents in which a new watermark is to be embedded. The extracted spatial frequency component is input to phase shift processors 232, which are arranged in correspondence with a plurality of scan lines. Phase shift processors 232 phase-shift the extracted specific frequency component. Each phase shift processor 232 is connected to corresponding amplitude modulator 233. Each amplitude modulator 233 is activated as needed on the basis of input Activity information. Each active amplitude modulator 233 adjusts the amplitude component of the phase-shifted signal on the basis of the contents (copy once, no-more copy, or the like) of input copy control information (CCI) in correspondence with the signal amplitude component of the original contents. (For example, each modulator changes the contents of the lower 7th and 8th bits of an amplitude component quantized to 8 bits in correspondence with the contents of CCI.)

Each amplitude modulator 233 is connected to corresponding adder 234. Each adder 234 adds the amplitude-adjusted signal component (corresponding to a new watermark) to the original contents. With the above process, a new watermark can be embedded in the original contents which contain the original watermark, thus generating new contents.

Original and new watermarks may have different formats by changing, e.g., the phase shift direction to the vertical and horizontal directions with respect to a frame. However, the present invention is not limited to the phase shift direction. For example, the display frame may be divided into two to embed an original watermark in the upper portion of the frame, and to embed a new watermark in the lower portion of the frame. In this way, various watermark formats may be adopted.

The watermark detection process by watermark detector 22 will be described below with reference to FIG. 15. (This detection process corresponds to the watermark detection process in processor 112 in FIG. 1, and also to the process of WM detector 1122 in FIG. 4 or WM detector 1122* in FIG. 5.)

FIG. 15 shows an example of the schematic structure of a watermark detection processor in watermark detector 22. As shown in FIG. 15, the watermark detection processor in watermark detector 22 comprises digital spatial frequency filter 221, digital phase shift processor (Phase Shift) 222, digital amplitude modulator (Amplitude Modulation) 223, digital phase correction circuit 224, and the like.

Spatial frequency filter 221 extracts a specific spatial frequency component from contents. Phase shift processor 222 phase-shifts the extracted specific spatial frequency component as needed. Upon reception of Activity information, amplitude modulator 223 adjusts the amplitude component of the phase-shifted signal in correspondence with the signal amplitude component of the original contents. Phase correction circuit 224 detects the phase-shift correlation value of the amplitude-adjusted signal component (output value from a Correlation block), and detects a watermark embedded in the contents on the basis of the detected correlation value and Shift Position information.

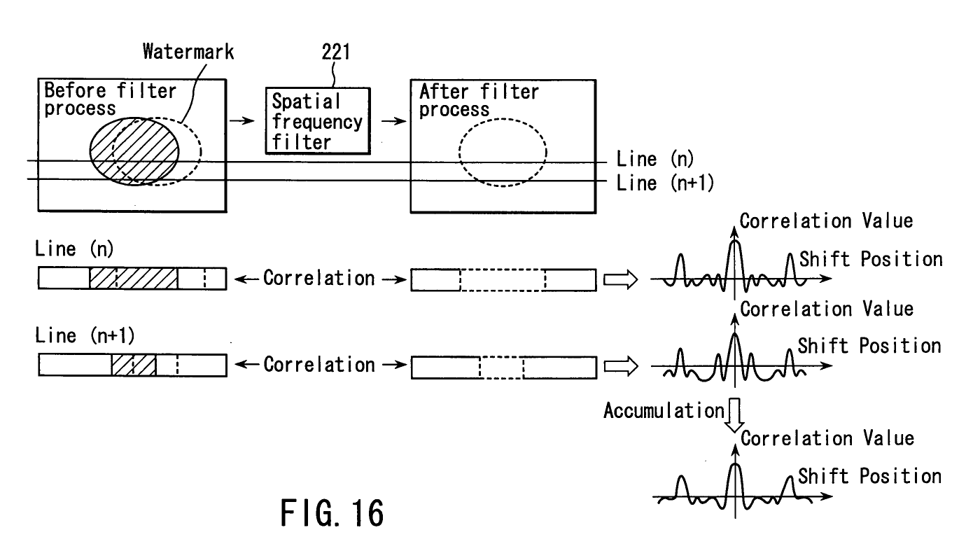

Detection of the phase-shift correlation value will be described in more detail below with reference to FIG. 16. As shown in FIG. 16, when contents (Input Image) are processed by spatial frequency filter (digital SFF) 221, the contents that have undergone the filter process (Filtered Image) are obtained. By adding (accumulating) waveform components for respective scans on a display frame in association with obtained Filtered Image, a high-precision, phase-shift correlation value detection signal is obtained. More specifically, by accumulating the amplitude components of Filtered Image for respective scan lines in the line arrangement direction, the magnitude of correlative components becomes relatively larger than components having no correlation with Filtered Image. As a result, the position (Shift Position) of Filtered Image can be accurately specified. In this way, watermark information can be extracted from the position of Filtered Image.

In the above description, recorder 20 rewrites the new watermark. However, the embodiment of the present invention is not limited to such specific arrangement. For example, a new watermark may be used as a mark for tracing a record using recorder 20. In this case, the new watermark need not be rewritten.

In the above description, the process for the once-copy contents has been explained. However, the present invention is not limited to such specific process. For example, the present invention can be applied to contents which are permitted to be copied a large number of times.

The above description has exemplified the case wherein the new watermark is embedded in addition to the original watermark. In this case, one or a plurality of new watermarks may be embedded. Even when a plurality of new watermarks are embedded, every time the original watermark is rewritten, the rewritten contents are displayed, but information associated with the plurality of new watermarks is not displayed.

In the contents recording/playback apparatus shown in FIG. 6, even contents whose copy control information other than a watermark has been illicitly canceled or tampered with, or even copy-free contents can be copyrighted to some extent. That is, when contents are copied (as digital or analog data) using the contents recording/playback apparatus shown in FIG. 6, a new watermark unique to this recording/playback apparatus is embedded in the copied new contents (contents copied once). When the new contents (contents copied once) are copied again by the contents recording/playback apparatus, a new watermark unique to this recording/playback apparatus is embedded again in the copied new contents (contents copied twice). In this way, every time contents are copied, a new watermark unique to the recording/playback apparatus is embedded in the contents, thus gradually lowering the quality of the contents. In this way, since the contents deteriorate as a result of repetitive copies, copy-free contents can be copyrighted to some extent.

According to the embodiment of the present invention, an apparatus for recording contents containing a watermark, and a method of recording contents containing a watermark, which are suitable for copyright protection, can be provided.

The advantages according to various embodiments of the present invention can be summarized as follows.

(01) Every time a watermark (original watermark) contained in contents is rewritten, copy control information contained in the watermark (original watermark) is displayed. With this information, an end user can recognize whether or not the contents can be copied, the number of allowable copies, and the like, thus preventing troubles.

(02) The embedding method of an original watermark has been standardized. Hence, copy control information contained in this original watermark may be tampered with on the user side. On the other hand, the embedding method of a new watermark unique to the recorder is not open to the public, and the presence of the new watermark itself is kept in secret. That is, by embedding a new watermark unique to the recorder in the contents in addition to the original watermark, history management of the contents becomes easy, thus reinforcing the copyright protection function. For example, when copy control information contained in the original watermark does not match that contained in the new watermark unique to the recorder, it is determined that the copy control information has been tampered with. In this way, by embedding a new watermark unique to the recorder in contents, illicit copy prevention performance of the contents can be greatly improved. The present invention can be applied to a case wherein contents are recorded on an HDD or magnetic tape in addition to a case wherein contents are recorded on an optical disc.

(03) Upon outputting an analog output of digital contents with a watermark, that watermark is embedded in the analog output. Upon outputting an analog output of digital contents without any watermark, if its copy control information indicates copy inhibition, an internally generated watermark is embedded in the analog output. Then, a watermark is embedded in the analog output to be copy-protected (even when the original digital contents have no watermark). For this reason, an analog output of existing contents to be copy-protected without any watermark (e.g., existing DVD video software in which no watermark is recorded) can be protected from being illicitly copied (even if its analog output can be recorded by a copy protect canceller which were available in some markets, it is easily recognized based on the watermark in the recorded contents that video recording from that analog output is an illicit copy).

(04) When device (decoder) 110 according to the embodiment of the present invention is inserted between source device 100 and sink device 120, an illicit copy at the stage of an analog signal can be easily found and prevented (by the watermark embedded in the analog signal) without any special adapter “which can never be detached once it is attached”, which must be attached to the sink device by a service person.

(05) No watermark is embedded in HD (High Definition) video contents which have already arrived on the market by, e.g., BS digital broadcast, and such contents cannot undergo robust copy protection control. However, a watermark according to the present invention can be embedded in such existing HD video contents based on CGMS-A in case of analog video contents or CGMS-D in case of digital video contents (if CGMS-A or CGMS-D contains copy inhibition information). This method has high compatibility to contents which have already arrived on the market, and can protect such contents using watermarks without posing any problems of compatibility.

(06) Device (decoder) 110 according to the embodiment of the present invention can be realized by a relative small-scale arrangement. For this reason, when this device 110 is mass-produced as ICs (or as a built-in function of other LSIs), products can be developed with low cost.

Note that the present invention is not limited to the aforementioned embodiments, and various modifications may be made without departing from the scope of the invention when it is practiced. The respective embodiments may be combined as needed as long as possible, and combined effects can be obtained in such case. Furthermore, the embodiments include inventions of various stages, and various inventions can be extracted by appropriately combining a plurality of disclosed required constituent elements. For example, even when some required constituent elements are omitted from all required constituent elements described in the embodiment, an arrangement from which the required constituent elements are omitted can be extracted as an invention as long as the problems that have been discussed in the paragraphs of the problems to be solved by the invention, and the effects that have been explained in the paragraphs of the effect of the invention can be obtained.

As described in detail above, according to the present invention, illicit copies after digital converts are converted into an analog signal can be prevented (or suppressed).

What is claimed is:

1. A device for receiving a digital input in which at least one of a watermark and copy control information other than the watermark is inserted as needed, and outputting an analog output corresponding to the digital input, comprising:
a first unit configured to output, when the watermark is inserted in the digital input, an analog output with that watermark; and
a second unit configured to insert, when the watermark is not inserted in the digital input but the inserted copy control information contains copy limitation information, a predetermined watermark in an analog output, and to output the analog output with the watermark.

2. A device according to claim 1, wherein the digital input contains at least one of video contents and audio contents,
when the watermark is inserted in a digital input of the video contents, an analog video output with that watermark is output,
when the watermark is not inserted in the digital input of the video contents but the inserted copy control information contains copy limitation information, a first predetermined watermark is inserted before analog conversion, and an analog video output with the watermark is output,
when the watermark is inserted in a digital input of the audio contents, an analog audio output with that watermark is output, and
when the watermark is not inserted in the digital input of the audio contents but the inserted copy control information contains copy limitation information, a second predetermined watermark is inserted before analog conversion, and an analog audio output with the watermark is output.

3. A device according to claim 2, wherein the watermark to be inserted in the analog video output of the video contents is inserted in a baseband of a composite analog video output.

4. A device according to claim 2, wherein the watermark to be inserted in the analog video output of the video contents is inserted in a color difference signal of a component analog video output.

5. A device according to claim 2, wherein the watermark to be inserted in the analog audio output of the audio contents is inserted in at least one of a frequency range not more than an audio playback frequency band lower limit and a frequency range not less than an audio playback frequency band upper limit.

6. A method of receiving a digital input in which at least one of a watermark and copy control information other than the watermark is inserted as needed, and outputting an analog output corresponding to the digital input, comprising:
outputting, when the watermark is inserted in the digital input, an analog output with that watermark; and
inserting, when the watermark is not inserted in the digital input but the inserted copy control information contains copy limitation information, a predetermined watermark in an analog output, and outputting the analog output with the watermark.

7. A disk or disc configured to record the analog output obtained by the method of claim 6.
